(19) United States
(12) Patent Application Publication
(10) Pub. No.: US 2014/0149441 A1
(43) Pub. Date: May 29, 2014

(54) SYSTEM AND METHOD FOR MATCHING PERSONS IN AN OPEN LEARNING SYSTEM

(71) Applicant: FUJITSU LIMITED, Kanagawa (JP)

(72) Inventors: Jun Wang, San Jose, CA (US); Kanji Uchino, San Jose, CA (US)

(73) Assignee: FUJITSU LIMITED, Kanagawa (JP)

(21) Appl. No.: 13/689,242

(22) Filed: Nov. 29, 2012

(51) Int. Cl. G06F 17/30

(52) U.S. Cl. CPC G06F 17/30386
USPC 707/758

(57) ABSTRACT

In one embodiment of the present disclosure, a method for matching persons in an open learning environment is presented. The method includes gathering helper information and helpee information and calculating a measure of similarity between the helper information and the helpee information. The method further includes calculating a matching score, wherein the matching score is a function of the measure of similarity between the helper information and the helpee information, and generating a list of helper candidates ranked according to the matching score.

### TECHNICAL FIELD

This disclosure relates generally to methods and systems for the automatic and reciprocal matching of persons in open learning systems.

### BACKGROUND

Matching of people to resources or learning materials is common, but little research has been done regarding matching people to people. Person-to-person matching may be useful in the context of matching mentors with mentees, peer learning partners, and dating candidates.

Existing matching systems include a very large number of persons or matching candidates. Many of these systems focus on one-way matching, rather than reciprocal matching. A few existing systems utilize reciprocal matching, but do so in a closed system (i.e., based only on profile and activity information internal to the system), with no mechanism for utilizing information about a user's external activity or social connections. The Mentor Matching System of the U.S. Department of Health and Human Services is an example of this type of system. Still other existing systems create a network of users to enhance communication among a group (i.e., online learning forums such as www.edmodo.com and www.lore.com), but do not match users within the group.

### SUMMARY

In one embodiment of the present disclosure, a method for matching persons in an open learning environment is presented. The method includes gathering helper information and helpee information and calculating a measure of similarity between the helper information and the helpee information. The method further includes calculating a matching score, wherein the matching score is a function of the measure of similarity between the helper information and the helpee information, and generating a list of helper candidates ranked according to the matching score.

In another embodiment of the present disclosure, an article of manufacture includes a non-transitory, computer-readable medium and computer executable instructions carried on the computer-readable medium. The computer readable instructions are readable by a processor and, when executed, cause the processor to gather helper information and helpee information and calculate a measure of similarity between the helper information and the helpee information. The computer readable instructions, when executed, further cause the processor to calculate a matching score, wherein the matching score is a function of the measure of similarity between the helper information and the helpee information, and generate a list of helper candidates ranked according to the matching score.

In yet another embodiment of the present disclosure, an open learning system includes a memory, a processor coupled to the memory, a network interface, and computer executable instructions carried on the memory. The computer readable instructions are readable by a processor and, when executed, cause the processor to gather helper information and helpee information and calculate a measure of similarity between the helper information and the helpee information. The computer readable instructions, when executed, further cause the processor to calculate a matching score, wherein the matching score is a function of the measure of similarity between the helper information and the helpee information, and generate a list of helper candidates ranked according to the matching score.

### BRIEF DESCRIPTION OF THE DRAWINGS

FIG. 1 illustrates an open learning environment in accordance with one embodiment of the present disclosure;

FIG. 2 illustrates an open learning system in accordance with one embodiment of the present disclosure;

FIG. 3 illustrates a method of matching persons in an open learning environment in accordance with one embodiment of the present disclosure;

FIG. 4 illustrates a method of generating helper and helpee knowledge and preference vector(s) in accordance with one embodiment of the present disclosure;

FIG. 5 illustrates a method of refining a helpee's preference vector(s) in accordance with one embodiment of the present disclosure; and

FIG. 6 illustrates a method of refining a helper's preference vector(s) in accordance with one embodiment of the present disclosure.

### DETAILED DESCRIPTION

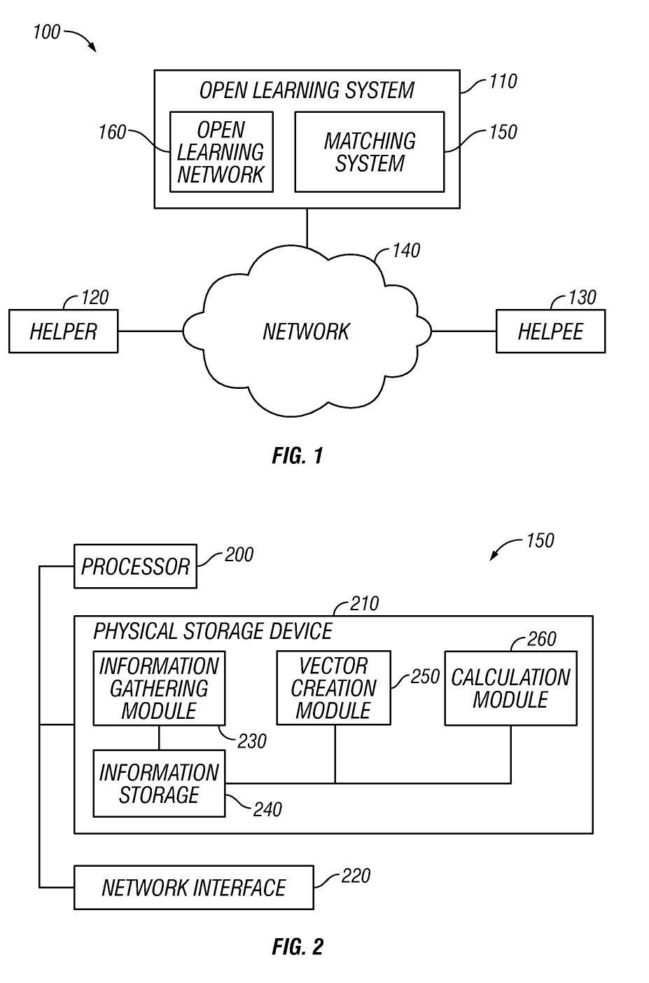

Particular embodiments and their advantages are best understood by reference to FIGS. 1 through 6, wherein like numbers are used to indicate like and corresponding parts.

The teachings of this disclosure may be used to automatically and reciprocally match users based on a user's profile information and interaction information (e.g., a user's interaction with an open learning environment and connections in a social network). A user's profile information may contain both explicit and implicit information regarding the user's knowledge and preferences. For example, a user's explicit profile information may include information regarding a user's education, employment history, location, age, gender, etc. Such information may be gathered from structured profiles created by the user in the open learning environment and/or other networks (e.g., LinkedIn, Facebook). The implicit profile information may include information regarding a user's activity in an open leaning environment and/or other network, such as the user's publications, sites and/or articles the user has bookmarked or tagged, topics on which the user has conducted searches, articles the user has read, etc. Utilizing information extracted from a user's structured profile(s) captures only the user's explicit preferences, while utilizing information regarding the user's activity within an open learning environment and/or other network provides a way to capture the user's implicit preferences as demonstrated by the user's actions.

FIG. 1 illustrates an open learning environment 100, in which a helper 120 and a helpee 130 may access an open learning system 110 via a network 140. A helper 120 may be a user that offers to help other users in the open learning environment. Similarly, a helpee 130 may be a user that seeks help from other users in the open learning environment. In some embodiments, a particular user may be both a helper 120 and a helpee 130. For example, a particular user may help other users in learning one topic and get help from other users in learning another topic.

Helper 120 and helpee 130 may access the open learning system 110 through any resource, component, or device of the open learning environment 100 that is in electronic communication with the network 140. The open learning system 110 may include a matching system 150 and an open learning network 160, which may be configured to permit users to create, save, view, and/or share information in a learning repository and to communicate directly with other network users.

The open matching system 150 may be configured to automatically match and recommend or connect a helper 120 to a helpee 130 based on helper and helpee information gathered by the matching system 150. The gathering of helper and helpee information is discussed in detail in conjunction with FIG. 2. Although FIG. 1 depicts the matching system 150 as part of the open learning system 110, the matching system 150 could, in some embodiments, be separate from the open learning system 110.

FIG. 2 illustrates the matching system 150, which may include a processor 200, a physical storage device 210, and a network interface 220. Processor 200 may execute program instructions, interpret data, and/or process data stored by physical storage device 210 and/or another component of the open learning system 110.

Physical storage device 210 may be communicatively coupled to processor 200 and may comprise any system, device, or apparatus operable to retain program instructions or data for a period of time (e.g., computer-readable media). Physical storage device 210 may include random access memory (RAM), electrically erasable programmable read-only memory (EEPROM), a PCMCIA card, flash memory, solid state disks, hard disk drives, magnetic tape libraries, optical disk drives, magneto-optical disk drives, compact disk drives, compact disk arrays, disk array controllers, and/or any suitable selection or array of volatile or non-volatile memory that retains data after power to open learning system 110 is turned off. Although the embodiment shown in FIG. 2 depicts a single physical storage device, the physical storage device 210 may include any number of physical storage devices.

In some embodiments, physical storage device 210 may include an information gathering module 230, information storage 240, a vector creation module 250, and a calculation module 260. In some embodiments, the information gathering module 230 may be a set of computer-readable instructions that, when executed by the processor, result in the gathering of helper and helpee information from various sources (e.g., the Internet, an intranet, servers, databases, etc.). A helper or helpee may grant the matching system access, so that the matching system may gather helper or helpee information located on systems external to the open learning environment 100. There may be many different ways to retrieve helper and helpee information. For example, a web crawler, implemented as computer software, may crawl the Internet or an intranet to retrieve different types of helper and helpee information. The helper and helpee information gathered by the information gathering module 230 may be stored in information storage 240.

The helper information may include helper profile information and helper interaction information. Similarly, the helpee information may include helpee profile information and helpee interaction information. The profile information of a helper or helpee may include both explicit and implicit information regarding the helper or helpee's knowledge and preferences. For example, a helper or helpee's explicit profile information may include information regarding a user's education, employment history, location, age, gender, etc. Such information may be gathered from structured profiles created by the user in the open learning environment, as well as external social and professional networks (e.g., LinkedIn, Facebook). A helper or helpee's implicit profile information may include information regarding a user's activity in an open leaning environment and/or other network, such as search terms entered by the user, documents or articles viewed by the user, sites and/or pages bookmarked or tagged by the user, and/or a list of the user's publications.

The interaction information of a helper or helpee may include information regarding the user's activity within the open learning environment and connections within a social network. In particular embodiments, the information regarding a user's activity within the open learning environment may include the time the user is engaged in the open learning environment and the number of helpers or helpees with which the user is currently connected. The information regarding a user's connections within a social network may include, among other things, whether the helper and the helpee are connected in the social network or whether the helper and the helpee have a shared connection in the social network (i.e., the helper and the helpee are mutually connected to third user).

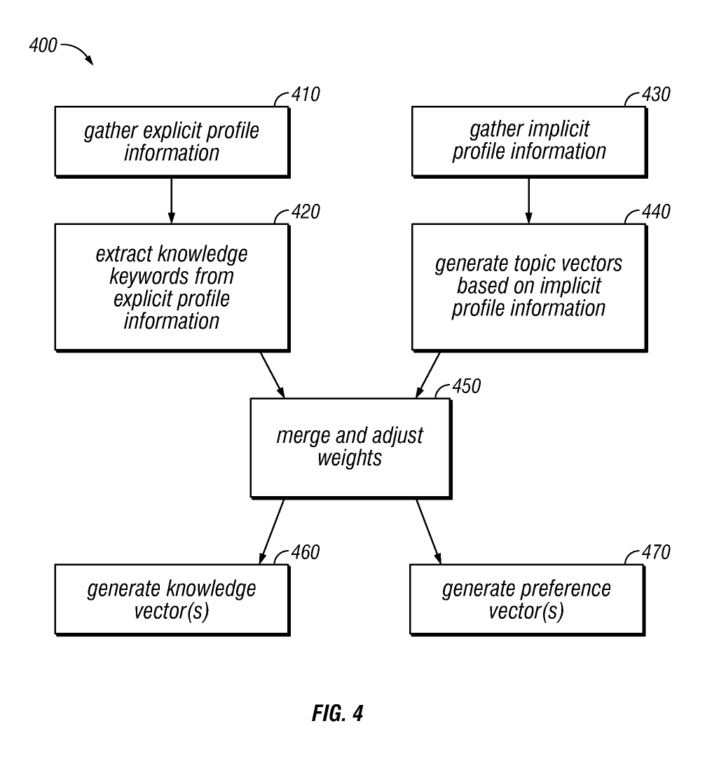

In some embodiments, the vector creation module 250 may be a set of computer-readable instructions that, when executed by the processor, generate helper and helpee knowledge and preference vectors. Words and phrases used to describe the knowledge and interests of a helper or helpee may be extracted from the helper and helpee profile information using a text mining algorithm. The keywords extracted from the helper and helpee profile information may be used to construct helper and helpee knowledge and preference vectors, which may be in the form of a term vector model (e.g., an algebraic model for representing objects, such as text, as vectors). A term vector model may be defined as: V=((t₁,w₁), (t₂,w₂), . . . , (tₙ,Wₙ)), where t is a textual term used to describe the knowledge and interests of a helper or helpee, w is the weight applied to that term, and n is the total number of unique textual terms. An exemplary method of generating term vector models is discussed in U.S. application Ser. No. 13/240,913, entitled “Information Managing and Networking” The generation of knowledge and preference vectors is discussed in more detail in conjunction with FIG. 4.

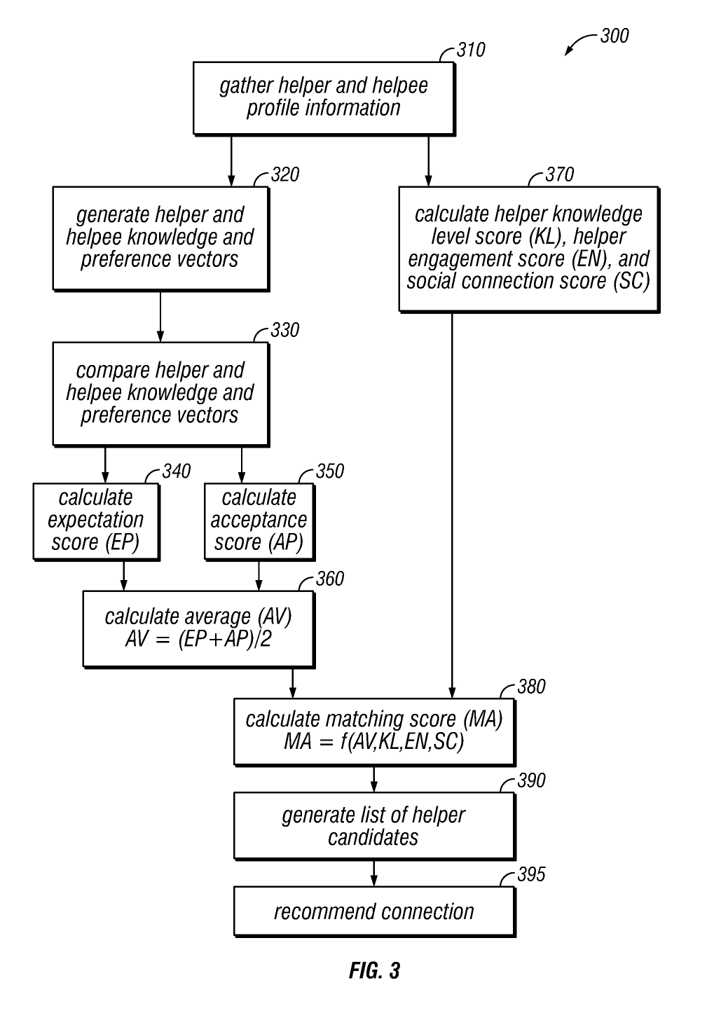

In some embodiments, the calculation module 260 may be a set of computer-readable instructions that, when executed by the processor, calculate various scores used to measure the compatibility between a helper and a helpee. Theses scores and the equations used to calculate them are discussed in further detail in conjunction with FIG. 3.

Network interface 220 may be any suitable system, apparatus, or device operable to serve as an interface between the open learning system 110 and the network 140. Network interface 220 may enable open learning system 110 to communicate with the helper 120, the helpee 130, and/or any element associated with the open learning environment 100 using any suitable transmission protocol and/or standard, including without limitation, Fibre Channel, Frame Relay, Asynchronous Transfer Mode (ATM), Internet protocol (IP), other packet-based protocol, small computer system interface (SCSI), Internet SCSI (iSCSI), advanced technology attachment (ATA), serial ATA (SATA), advanced technology attachment packet interface (ATAPI), serial storage architecture (SSA), integrated drive electronics (IDE), and/or any combination thereof.

FIG. 3 illustrates an example method 300 for matching persons in an open learning environment. Method 300 may be implemented in an online open learning environment. In one embodiment, method 300 begins at step 310, with the gathering of helper information and helpee information. As discussed above in conjunction with FIG. 2, the helper and helpee information may include both profile and interaction information gathered from various sources (e.g., the Internet, an intranet, servers, databases, etc.).

At step 320, the helper and helpee information may be used to generate helper and helpee knowledge and preference vectors. The knowledge and preference vectors of a particular helper and/or helpee may contain one or more topic vectors, each of which is related to a particular topic. For example, consider a user who has published papers on the topic of social network analysis and sentimental analysis. Topic vectors on both social network analysis and sentimental analysis may be constructed for that user. As discussed above in conjunction with FIG. 2, terms used to describe the interests and knowledge of a helper or helpee may be used to construct a term vector model, which may be defined as: V=((t₁,w₁), (t₂,w₂), . . . , ((tₙ,wₙ)), where t is a textual term used to describe the knowledge and interests of a helper or helpee, w is the weight applied to that term, and n is the total number of unique textual terms. The generation of helper and helpee knowledge and preference vectors is discussed in more detail in conjunction with FIG. 4.

At step 330, the helper and helpee knowledge and preference vectors may be compared. Based on this comparison, an expectation score may be calculated at step 340 and an acceptance score may be calculated at step 350. Steps 340 and 350 are shown in FIG. 3 occurring in parallel, but these steps could occur in series.

The expectation score and the acceptance score may be a two-way measurement used to gauge whether the match between the helper and the helpee will satisfy the needs and preferences of both users. The expectation score may be a measure of the similarity between the helper knowledge vector and the helpee preference vector. The acceptance score may be a measure of the similarity between the helper preference vector and the helpee knowledge vector. The similarity between two vectors may be calculated using the following equation:

$$cosine ( {v}_{1} , {v}_{2} ) = \frac{{v}_{1} * {v}_{2}}{\vert {v}_{1} \vert \vert {v}_{2} \vert}$$

where v₁ is the first vector and v₂ is the second vector. In some embodiments, the expectation score (EP) may be calculated using the following equation:

$$E P = cosine ( {v}_{helper\_knowledge} , {v}_{helpee\_preference} ) = \frac{{v}_{helper\_knowledge} * {v}_{helpe\_preference}}{\vert {v}_{helper\_knowledge} \vert \vert {v}_{helpee\_preference} \vert}$$

Similarly, the acceptance score (AP) may be calculated as follows:

$$A P = cosine ( {v}_{helper\_preferencee} , {v}_{helpee\_knowledge} ) = \frac{{v}_{helper\_preference} * {v}_{helpee\_knowledge}}{\vert {v}_{helper\_preference} \vert \vert {v}_{helpee\_knowledge } \vert}$$

At step 360, an average of the expectation score and the acceptance score may be calculated. Averaging the expectation score and acceptance score may serve as a way to balance the needs and preferences of both the helper and the helpee.

At step 370, a helper knowledge level score, a helper engagement score, and a social connection score may be calculated based on the helper and helpee information gathered in step 310.

The helper knowledge level score may be a measure of the helper's education level and experience level, which may be extracted from the helper profile information. Both the helper's education level and experience level may be represented by a numerical value. For example, a bachelor's degree may be equivalent to a 1, a master degree to a 2, and a doctorate to a 3. Similarly, a helper's experience level may be represented by the number of years the helper has worked in a particular field. Using the numerical values representing a helper's education level and experience level, the knowledge level score (KL) may be calculated using the following equation:

$$K L = log ( education\_level ) + log ( \frac{experience\_level}{N} )$$

where N is a constant such as 10, which may be used to equally weight the education level and experience level. For illustrative purposes, consider a helper who holds a doctorate degree and has worked in a particular field for twenty-one years. Using the equation set forth above, the helper's knowledge level score (KL) may be calculated as follows:

$$K L = log ( 3 ) + log ( \frac{21}{10} ) = 0.8$$

The helper engagement score may be calculated using information extracted from the helper interaction information. In some embodiments, the engagement score may be positively related to the time the helper is engaged in the open learning environment and inversely related to the number of people currently mentored by the helper. For example, the helper engagement score (EN) may be represented by the following equation:

$$E N = {e}^{\frac{- A}{B}}$$

where A is the number of people currently mentored by the helper and B is the time the helper is engaged in the open learning environment 100. In some embodiments, the time the helper is engaged in the open learning environment may be measured by the helper's average number of log-ins per day or the average time the helper spends logged-in to open learning system 110. These measures may be helpful in matching because a helper who is engaged in the open learning environment may be more likely to help. Similarly, a helper who is currently matched with fewer helpees may have the capacity to help an additional user. For illustrative purposes, consider a helper who is currently matched with two helpees and who, on average, accesses the open learning environment once per day. Using the equation set forth above, the helper's engagement score (EN) may be calculated as follows:

$$E N = {e}^{\frac{- 2}{1}} = 0.135$$

The social connection score may be calculated using information extracted from the helper and helpee interaction information. In some embodiments, the social connection score may be a measure of connectedness between the helper and the helpee in a social network (e.g., LinkedIn or Facebook). The social connection score may be inversely related to the graphical distance between the helper and the helpee in the social network and positively related to the number of paths between the helper and the helpee in the social network. For example, the social connection score (SC) may be represented by the following equation:

$$S C = {e}^{\frac{- C}{D}}$$

where C is the graphical distance between the helper and the helpee in the social network and D is the number of paths between the helper and the helpee in the social network.

There may be several different types of paths between a helper and a helpee in a social network. For example, the helper and the helpee may be directly connected, the two may share a mutual connection, or the two may be connected via a path between several other users. For example, a helper and a helpee may be said to be connected via a mutual connection where the helper is connected to a person who is also connected to the helpee. As another example, a helper and a helpee may be connected via a path between several other users where the helper is connected to a first person, who is connected to a second person, who is connected to a third person, who in turn is connected to the helpee. Although a chain of three users was used in this example, the chain of users connecting a helper and a helpee could be longer or shorter.

The graphical distance between the helper and the helpee may be calculated by counting the number of steps it would take to get from the helper to the helpee in the social network. Thus, the graphical distance between a helper who is connected to a first person, who is in turn connected to a second person, who is in turn connected to a third person, who is in turn connected to a helper, is calculated by counting the number of steps between the helper and the helpee. In this example, the graphical distance between the helper and the helpee would be four. As mentioned above, there is only a single path between the helper and the helpee in this example. Thus, using the equation set forth above, the social connection score (SC) for this pair may be calculated as follows:

$$S C = {e}^{\frac{- 4}{1}} = 0.02$$

As another example, consider a helper and a helpee who share two mutual connections in a social network. The distance between the helper and the helpee in the social network is two and there are two paths between them. Using the equation set forth above, the social connection score (SC) may be calculated as follows:

$$S C = {e}^{\frac{- 2}{2}} = 0.368$$

At step 380, a matching score may be calculated. In some embodiments, the matching score is a function of the social connection score and an average of the expectation score and acceptance score. The matching score may be calculated using linear aggregation. For example, the matching score (MA) may be represented by the following equation: MA=w1*AV+w2*SC, where AV is the average of the expectation score and acceptance score, SC is the social connection score, and w1 and w2 are weights used to adjust the scale of AV and SC.

In other embodiments, the matching score may be a function of the helper knowledge level score and the helper engagement score, in addition to the social connection score and an average of the expectation score and acceptance score. In these embodiments, the matching score (MA) may be represented by the following equation: MA=w1*AV+w2*KL+w3*SC+w4*EN, where AV is the average of the expectation score and acceptance score, KL is the helper knowledge level score, SC is the social connection score, EN is the helper engagement level score, and w1, w2, w3, and w4 are weights used to adjust the scale of AV, KL, SC, and EN, respectively. The values of w1, w2, w3, and w4 may be initially determined using a heuristic rule. For example, in some embodiments, initial values of w1=1, w2=0.1, w3=0.1, and w4=0.1 could be used. When data regarding actual helper and helpee matching is accumulated, the values of these parameters may be refined using regression to derive optimal parameters.

At step 390, a list of helper candidates may be generated and ranked based on the matching score for each helper. At step 395, a connection between the highest ranked helper and the helpee may be recommended in the open learning environment. In other embodiments, a list of the top helper candidates, based on matching score, may be provided to the helpee and the helpee may then select a helper candidate from the list.

In some embodiments, an invitation may be sent to the helper and/or the helpee to establish the connection. Once the invitation has been accepted, a connection between the helper and the helpee may be recommended in the opening learning environment. Matching system 150 may send an invitation to both the helper and the helpee and, if the invitation is accepted, create a connection between the helper and the helpee. When the interaction between the helper and the helpee is completed, the connection may be maintained, but may be labeled as an inactive connection.

FIG. 4 illustrates an example method 400 for generating the helper and helpee knowledge and preference vectors. As discussed above, the helper and helpee knowledge and preference vectors may be generated using keywords extracted from the helper and helpee profile information.

At step 410, explicit helper and helpee profile information may be gathered. As discussed above, the explicit helper and helpee profile information may include information regarding a user's education, employment history, location, age, and/or gender. Such information may be gathered from structured profiles created by the user in the open learning environment and external social and professional networks (e.g., LinkedIn, Facebook). The explicit helper and helpee profile information may be stored on the physical storage device 220. The method of gathering helper and helpee information is explained in more detail above in conjunction with step 310 of method 300, shown in FIG. 3.

At step 420, helper knowledge keywords and helpee knowledge keywords may be extracted from the explicit helper and helpee profile information. Words and phrases used to describe the knowledge of a helper or helpee may be extracted from the helper and helpee's structured profiles using a text mining algorithm.

At step 430, implicit helper and helpee profile information may be gathered. As discussed above, the implicit helper and helpee profile information may include information regarding a user's activity in an open leaning environment and/or other network, such as search terms entered by the user, documents or articles viewed by the user, sites and/or pages bookmarked or tagged by the user, and/or a list of the user's publications. The implicit helper and helpee profile information may be stored on the physical storage device 220. The method of gathering helper and helpee information is explained in more detail above in conjunction with step 310 of method 300, shown in FIG. 3.

At step 440, helper and helpee topic vectors may be generated using the implicit helper and helpee profile information. Words and phrases used to describe the interests of a helper or helpee may be extracted from the helper and helpee's implicit profile information using a text mining algorithm. These words and phrases may be used to construct topic vectors, which may be in the form of a term vector model. An exemplary method of generating term vector models is discussed in U.S. application Ser. No. 13/240,913, entitled “Information Managing and Networking.”

At step 450, the knowledge keywords for a helper or helpee may be merged with the helper or helpee's topic vectors and used to increase the weight of the terms in the topic vectors. If a word appears as both a knowledge keyword and a term in the topic vectors of a helper or helpee, the weight of that term in the helper or helpee's topic vectors may be increased. Different factors may be used to increase the weight of a particular term. The factors used to increase the weight of a term may depend on the type of information to which the term relates (e.g., education, employment, etc.) and/or the age of the information to which the term relates. The weight of a particular term may be increased by a factor chosen based on the importance of that type of information in the matching process. Additionally, the weight of a particular term may be increased by a factor related to the age of the information, which may be calculated using the following formula: F=exp(−λ*A), where F is the factor by which the weight is to be increased, A is the age of the information in years, and λ is a constant (e.g., 0.5).

Consider, for example, a particular helper for which the terms “opinion” and “mining” appear in the helper's interest vectors and knowledge keywords. Both terms relate to the helper's doctorate degree that was obtained one year ago. The weight of the terms might be increased by a factor of 0.3 simply because the terms relate to the helper's education. The weight of the terms may also be increased based on the recentness of the education to which the terms are related. The factor by which to increase the weight based on the recentness of the helper's education may be calculated as follows: F=exp(−λ*1)=0.61. The adjusted weight of each term may be calculated as follows: W_{A}(opinion)=(0.3*0.61+1)*W, where W_{A} is the adjusted weight and W is the original weight; and W_{A}(mining)=(0.3*0.61+1)*W, where W_{A} is the adjusted weight and W is the original weight.

At step 460, the helper and helpee knowledge vectors may be generated using the adjusted topic vectors. A helper and/or helpee's knowledge vectors may be equivalent to the adjusted topic vectors for the helper and/or helpee.

At step 470, the helper and helpee preference vectors may be generated based on the adjusted topic vectors. A helper or helpee may select from the adjusted topic vectors a topic vector (or vectors) related to a subject (or subjects) on which the user is seeking or offering help. The selected topic vector(s) may be used as the helper or helpee's preference vector(s). In another embodiment, the helper or helpee may manually enter a topic on which the user is seeking or offering help. A term vector model may be constructed based on that topic and used as the helper or helpee's preference vector(s).

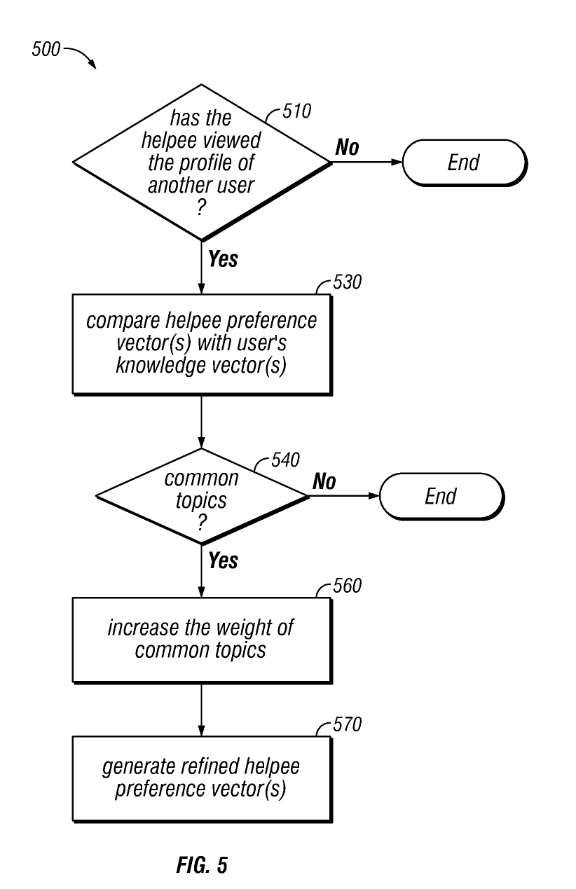

FIG. 5 illustrates an example method 500 for refining a helpee's preference vector(s). At step 510, a determination may be made as to whether the helpee has viewed the profile of another user (or other users). If so, the method may proceed to step 530. If not, the method may end.

At step 530, the preference vector(s) of the helpee may be compared to the knowledge vector(s)s of the user (or users) whose profile(s) the helpee has viewed. At step 540, a determination may be made regarding whether there are common topics between the preference vector(s) of the helpee and the knowledge vector(s) of the user (or users) whose profile(s) the helpee has viewed. If common topics exist, the method may proceed to step 560. If not, the method may end.

At step 560, the helpee's preference vector(s) may be refined based on the existence of the common topic(s). For example, consider a helpee who has selected “social matching” as a topic for seeking help and has viewed the profile of a particular user whose knowledge vectors include the same topic. The helpee's refined preference vector on “social matching” may be expressed as follows: V_{new}=V+μ*log(1+N/M)*P, where V is the original preference vector of the helpee on “social matching,” μ and M are constants, N is the number of time the helpee has viewed the user's profile, and P is the knowledge vector of the user on “social matching.” The constant μ may be used to scale the impact on the original preference vector V of the user's knowledge vector P. In some embodiments, μ may be a number between zero and one.

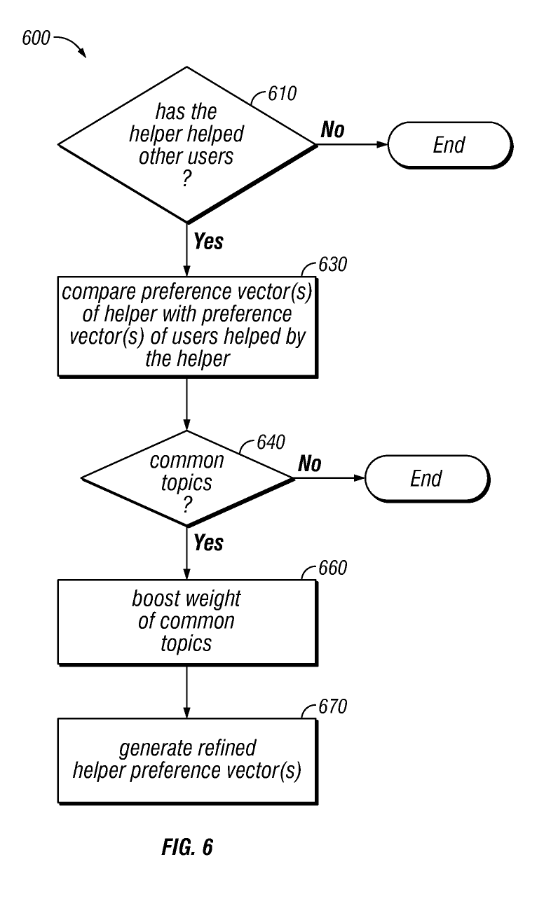

FIG. 6 illustrates an example method 600 for refining a helper's preference vector(s). At step 610, a determination may be made regarding whether the helper has helped other users in the open learning environment. If so, the method may proceed to step 630. If not, the method may end.

At step 630 the preference vector(s) of the helper may be compared to the preference vector(s) of the users the helper has helped. At step 640, a determination may be made regarding whether there are common topics between the preference vector(s) of the helper and the preference vector(s) of the users the helper has helped. If common topics exist, the method may proceed to step 660. If not, the method may end.

At step 660, the helper's preference vector(s) may be refined based on the existence of the common topic(s). For example, consider a helper who is currently connected to two helpees whose preference vectors show they have an interest in learning about “people-to-people matching.” The helpees' preference vectors on “people-to-people matching” may be used to refine the preference vector of the helper, who is likely helping them with topics related to people-to-people matching. The refined preference vector of the helper may be represented by the following equation: V_{new}=V+ρ*(S1+S2+Sη)/η, where V is the original preference vector of the helper on “people-to-people matching”; S1, S2, and Sη are the preference vectors of the helpees on “people-to-people matching”; η is the number of helpees currently connected to the helper; and ρ is a constant. The constant ρ may be used to scale the impact on the original preference vector V of the S1, S2, and Sη vectors. In some embodiments, p may be a number between zero and one.

Although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it (or that particular function) is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present invention have been described in detail, it should be understood that the various changes, substitutions, and alterations could be made hereto without departing from the spirit and scope of the invention.

What is claimed is:

1. A method for matching persons in an open learning environment, comprising:
gathering helper information and helpee information;
calculating a measure of similarity between the helper information and the helpee information;
calculating a matching score, wherein the matching score is a function of the measure of similarity between the helper information and the helpee information; and
generating a list of helper candidates ranked according to the matching score.

2. The method of claim 1, wherein
the helper information comprises explicit helper profile information, implicit helper profile information, and helper interaction information, the helper interaction information based on a helper's activity within an open learning environment and a helper's connections within at least one social network; and
the helpee information comprises explicit helpee profile information, implicit helpee profile information, and helpee interaction information, the helpee interaction information based on at least a helpee's activity within an open learning environment and a helpee's connections within at least one social network.

3. The method of claim 2, wherein calculating the measure of similarity between the helper information and the helpee information comprises:
generating at least one helper knowledge vector and at least one helper preference vector;
generating at least one helpee knowledge vector and at least one helpee preference vector; and
calculating an expectation score and an acceptance score, wherein the expectation score is a measure of similarity between the at least one helper knowledge vector and the at least one helpee preference vector and the acceptance score is a measure of similarity between the at least one helper preference vector and the at least one helpee knowledge vector; and
wherein the measure of similarity between the helper information and the helpee information is a function of the expectation score and the acceptance score.

4. The method of claim 3, wherein generating the at least one helper knowledge vector and the at least one helper preference vector comprises:
extracting a plurality of helper knowledge keyword from at least the explicit helper profile information;
generating a plurality of helper topic vectors, the plurality of helper topic vectors based at least on the implicit helper profile information;
generating a plurality of refined helper topic vectors by merging the plurality of helper knowledge keywords with the plurality of helper topic vectors and adjusting the weight of at least one term in the plurality of helper topic vectors;
creating at least one helper knowledge vector, the at least one helper knowledge vector based at least on the plurality of refined helper topic vectors; and
creating at least one helper preference vector, the at least one helper preference vector based at least on the plurality of refined helper topic vectors.

5. The method of claim 3, wherein generating the at least one helpee knowledge vector and the at least one helpee preference vector comprises:
extracting a plurality of helpee knowledge keyword from at least the explicit helpee profile information;
generating a plurality of helpee topic vectors, the plurality of helpee topic vectors based at least on the implicit helpee profile information;
generating a plurality of refined helpee topic vectors by merging the plurality of helpee knowledge keywords with the plurality of helpee topic vectors and adjusting the weight of at least one term in the plurality of helpee topic vectors;
creating at least one helpee knowledge vector, the at least one helpee knowledge vector based at least on the plurality of refined helpee topic vectors; and
creating at least one helpee preference vector, the at least one helpee preference vector based at least on the plurality of refined helpee topic vectors.

6. The method of claim 1, further comprising:
calculating a social connection score, wherein the social connection score is inversely related to a graphical distance between the helper and the helpee in the at least one social network and positively related to a number of paths between the helper and the helpee in the at least one social network; and
wherein the matching score is further a function of a social connection score.

7. The method of claim 2, further comprising:
calculating a helper knowledge level score using a helper education level and a helper experience level, the helper education level and the helper experience level extracted from the explicit helper profile information;
calculating a helper engagement score using information extracted from the helper interaction information, wherein the helper engagement score is positively related to a time the helper is engaged in the open learning environment and inversely related to a number of helpees currently mentored by the helper; and
wherein the matching score is further a function of the helper knowledge score and the helper engagement score.

8. An article of manufacture comprising:
a non-transitory, computer-readable medium; and
computer executable instructions carried on the computer-readable medium, the instructions readable by a processor and, when executed, causing the processor to:
gather helper information and helpee information;
calculate a measure of similarity between the helper information and the helpee information;
calculate a matching score, wherein the matching score is a function of the measure of similarity between the helper information and the helpee information; and
generate a list of helper candidates ranked according to the matching score.

9. The article of manufacture of claim 8, wherein:
the helper information comprises explicit helper profile information, implicit helper profile information, and helper interaction information, the helper interaction information based on a helper's activity within the open learning environment and a helper's connections within the at least one social network; and
the helpee information comprises explicit helpee profile information, implicit helpee profile information, and helpee interaction information, the helpee interaction information based on at least a helpee's activity within the open learning environment and a helpee's connections within the at least one social network.

10. The article of manufacture of claim 9, wherein calculating the measure of similarity between the helper information and the helpee information comprises:
generating at least one helper knowledge vector and at least one helper preference vector;
generating at least one helpee knowledge vector and at least one helpee preference vector; and
calculating an expectation score and an acceptance score, wherein the expectation score is a measure of similarity between the at least one helper knowledge vector and the at least one helpee preference vector and the acceptance score is a measure of similarity between the at least one helper preference vector and the at least one helpee knowledge vector;
wherein the measure of similarity between the helper information and the helpee information is a function of the expectation score and the acceptance score.

11. The article of manufacture of claim 10, wherein generating the at least one helper knowledge vector and the at least one helper preference vector comprises:
extracting a plurality of helper knowledge keyword from at least the explicit helper profile information;
generating a plurality of helper topic vectors, the plurality of helper topic vectors based at least on the implicit helper profile information;
generating a plurality of refined helper topic vectors by merging the plurality of helper knowledge keywords with the plurality of helper topic vectors and adjusting the weight of at least one term in the plurality of helper topic vectors;
creating at least one helper knowledge vector, the at least one helper knowledge vector based at least on the plurality of refined helper topic vectors; and
creating at least one helper preference vector, the at least one helper preference vector based at least on the plurality of refined helper topic vectors.

12. The article of manufacture of claim 10, wherein generating the at least one helpee knowledge vector and the at least one helpee preference vector comprises:
extracting a plurality of helpee knowledge keyword from at least the explicit helpee profile information;
generating a plurality of helpee topic vectors, the plurality of helpee topic vectors based at least on the implicit helpee profile information;
generating a plurality of refined helpee topic vectors by merging the plurality of helpee knowledge keywords with the plurality of helpee topic vectors and adjusting the weight of at least one term in the plurality of helpee topic vectors;
creating at least one helpee knowledge vector, the at least one helpee knowledge vector based at least on the plurality of refined helpee topic vectors; and
creating at least one helpee preference vector, the at least one helpee preference vector based at least on the plurality of refined helpee topic vectors.

13. The article of manufacture of claim 8, the computer executable instructions, when executed, further causing the processor to:
calculate a social connection score, wherein the social connection score is inversely related to a graphical distance between the helper and the helpee in the at least one social network and positively related to a number of paths between the helper and the helpee in the at least one social network; and
wherein the matching score is further a function of a social connection score.

14. The article of manufacture of claim 9, the computer executable instructions, when executed, further causing the processor to:
calculate a helper knowledge level score using a helper education level and a helper experience level, the helper education level and the helper experience level extracted from the explicit helper profile information;
calculate a helper engagement score using information extracted from the helper interaction information, wherein the helper engagement score is positively related to a time the helper is engaged in the open learning environment and inversely related to a number of helpees currently mentored by the helper; and
wherein the matching score is further a function of the helper knowledge score and the helper engagement score.

15. An open learning system comprising:
a memory;
a processor coupled to the memory;
a network interface; and
computer executable instructions carried on the memory, the instructions readable by the processor and, when executed, causing the processor to:
gather helper information and helpee information;
calculate a measure of similarity between the helper information and the helpee information;
calculate a matching score, wherein the matching score is a function of the measure of similarity between the helper information and the helpee information; and
generate a list of helper candidates ranked according to the matching score.

16. The open learning system of claim 15, wherein:
the helper information comprises explicit helper profile information, implicit helper profile information, and helper interaction information, the helper interaction information based on a helper's activity within the open learning environment and a helper's connections within the at least one social network; and
the helpee information comprises explicit helpee profile information, implicit helpee profile information, and helpee interaction information, the helpee interaction information based on a helpee's activity within the open learning environment and a helpee's connections within the at least one social network.

17. The open learning system of claim 16, wherein calculating the measure of similarity between the helper information and the helpee information comprises:
generating at least one helper knowledge vector and at least one helper preference vector;
generating at least one helpee knowledge vector and at least one helpee preference vector; and
calculating an expectation score and an acceptance score, wherein the expectation score is a measure of similarity between the at least one helper knowledge vector and the at least one helpee preference vector and the acceptance score is a measure of similarity between the at least one helper preference vector and the at least one helpee knowledge vector;
wherein the measure of similarity between the helper information and the helpee information is a function of the expectation score and the acceptance score.

18. The open learning system of claim 17, wherein generating the at least one helper knowledge vector and the at least one helper preference vector comprises:
extracting a plurality of helper knowledge keyword from at least the explicit helper profile information;
generating a plurality of helper topic vectors, the plurality of helper topic vectors based at least on the implicit helper profile information;
generating a plurality of refined helper topic vectors by merging the plurality of helper knowledge keywords with the plurality of helper topic vectors and adjusting the weight of at least one term in the plurality of helper topic vectors;
creating at least one helper knowledge vector, the at least one helper knowledge vector based at least on the plurality of refined helper topic vectors; and
creating at least one helper preference vector, the at least one helper preference vector based at least on the plurality of refined helper topic vectors.

19. The open learning system of claim 17, wherein generating the at least one helpee knowledge vector and the at least one helpee preference vector comprises:
extracting a plurality of helpee knowledge keyword from at least the explicit helpee profile information;
generating a plurality of helpee topic vectors, the plurality of helpee topic vectors based at least on the implicit helpee profile information;
generating a plurality of refined helpee topic vectors by merging the plurality of helpee knowledge keywords with the plurality of helpee topic vectors and adjusting the weight of at least one term in the plurality of helpee topic vectors;
creating at least one helpee knowledge vector, the at least one helpee knowledge vector based at least on the plurality of refined helpee topic vectors; and
creating at least one helpee preference vector, the at least one helpee preference vector based at least on the plurality of refined helpee topic vectors.

20. The open learning system of claim 15, the computer executable instructions, when executed, further causing the processor to:
calculate a social connection score, wherein the social connection score is inversely related to a graphical distance between the helper and the helpee in the at least one social network and positively related to a number of paths between the helper and the helpee in the at least one social network; and
wherein the matching score is further a function of the social connection score.

21. The open learning system of claim 16, the computer executable instructions, when executed, further causing the processor to:
calculate a helper knowledge level score using a helper education level and a helper experience level, the helper education level and the helper experience level extracted from the explicit helper profile information;
calculate a helper engagement score using information extracted from the helper interaction information, wherein the helper engagement score is positively related to a time the helper is engaged in the open learning environment and inversely related to a number of helpees currently mentored by the helper; and
wherein the matching score is further a function of the helper knowledge score and the helper engagement score.
